(19) United States
(12) Patent Application Publication
(10) Pub. No.: US 2026/0192199 A1
(43) Pub. Date: Jul. 9, 2026

(54) MAP TILE CONTROL METHOD AND APPARATUS IN GAME, AND ELECTRONIC DEVICE

(71) Applicant: NETEASE (HANGZHOU) NETWORK CO., LTD., Hangzhou, Zhejiang (CN)

(72) Inventor: Renfang WEI, Hangzhou, Zhejiang (CN)

(73) Assignee: NETEASE (HANGZHOU) NETWORK CO., LTD., Hangzhou, Zhejiang (CN)

(21) Appl. No.: 19/134,365

(22) PCT Filed: Aug. 4, 2023
(86) PCT No.: PCT/CN2023/111290

§ 371 Date: May 30, 2025

(30) Foreign Application Priority Data
Dec. 1, 2022 (CN) 202211537768.3

(51) Int. Cl. A63F 13/5378; A63F 13/2145; A63F 13/533; G06F 3/0485; G06F 3/0488

(52) U.S. Cl. CPC A63F 13/5378; A63F 13/2145; A63F 13/533; G06F 3/0485; G06F 3/0488; A63F 2300/308

(57) ABSTRACT

A method for controlling land plots in a game is provided. The method includes: providing a land plot marking control in a graphical user interface; in response to a trigger operation on the land plot marking control, controlling the graphical user interface to switch from a first game scene screen to a second game scene screen which includes at least a part of the plurality of virtual land plots; in response to a selection operation on the at least a part of the virtual land plots, determining a target virtual land plot, and performing graphical marking for the target virtual land plot; and in response to completion of the graphical marking, controlling the graphical user interface to switch from the second game scene screen to a third game scene screen.

### CROSS-REFERENCE TO RELATED APPLICATION(S)

This application is a U.S. National Stage of International Application No. PCT/CN2023/111290, filed on Aug. 4, 2023, which claims priority to Chinese patent application No. 202211537768.3 filed on Dec. 1, 2022 and entitled “METHOD AND APPARATUS FOR CONTROLLING LAND PLOTS IN GAME AND ELECTRONIC DEVICE”, the entire content of both of which is incorporated herein by reference for all purposes.

### TECHNICAL FIELD

The present disclosure relates to the technical field of game interactive control, and in particular to a method and apparatus for controlling land plots in a game and an electronic device.

### BACKGROUND

In the related art, when locating and selecting a target building in a game map, it is usually needed to find the target building in the game map, and then click/tap to select the target building to perform a corresponding operation, or to find the target building in a preset construction list to perform a corresponding operation.

### SUMMARY

According to an aspect of the present disclosure, the present disclosure provides a method for controlling land plots in a game. The method includes: providing a land plot marking control in a graphical user interface provided by a terminal device, wherein a first game scene screen formed by observing a game terrain scene of the game based on a first game perspective is displayed on the graphical user interface, and the game terrain scene comprises a plurality of virtual land plots; in response to a trigger operation on the land plot marking control, controlling the graphical user interface to switch from displaying the first game scene screen to displaying a second game scene screen formed by observing the game terrain scene based on a second game perspective, wherein the second game scene screen includes at least a part of the plurality of virtual land plots; in response to a selection operation on the at least a part of the virtual land plots, determining a target virtual land plot from the at least a part of the virtual land plots according to the selection operation, and performing graphical marking for the target virtual land plot; in response to completion of the graphical marking, controlling the graphical user interface to switch from displaying the second game scene screen to displaying a third game scene screen, wherein the third game scene screen is a game scene screen formed by observing the target virtual land plot.

According to an aspect of the present disclosure, the present disclosure provides an electronic device. The electronic device includes a processor and a memory. The memory stores machine executable instructions that can be executed by the processor. When the processor executes the machine executable instructions, the method for controlling land plots in a game described above is implemented.

According to an aspect of the present disclosure, a non-transitory computer-readable storage medium is provided. The computer-readable storage medium stores computer-executable instructions. When the computer-executable instructions are invoked and executed by a processor, the computer-executable instructions cause the processor to implement the method for controlling land plots in a game described above.

### BRIEF DESCRIPTION OF THE DRAWINGS

FIG. 1 is a flowchart of a method for controlling land plots in a game provided by an embodiment of the present disclosure;

FIG. 2 is a flowchart of another method for controlling land plots in a game provided by an embodiment of the present disclosure;

FIG. 3 is a schematic diagram of displaying of a target virtual land plot provided by an embodiment of the present disclosure;

FIG. 4 is a flowchart of another method for controlling land plots in a game provided by an embodiment of the present disclosure;

FIG. 5 is a schematic diagram of a structure of an apparatus for controlling land plots in a game provided by an embodiment of the present disclosure;

FIG. 6 is a schematic diagram of a structure of an electronic device provided by an embodiment of the present disclosure.

### DETAILED DESCRIPTION

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are a part of the embodiments of the present disclosure, rather than all of the embodiments. Components of the embodiments of the present disclosure described and shown in the drawings here may be arranged and designed in various different configurations.

In the related art, when locating and selecting a target building in a game map, it is usually needed to find the target building in the game map, and then click/tap to select the target building to perform corresponding operation(s), or to find the target building in a preset construction list to perform corresponding operation(s). However, it is difficult for the methods to quickly locate the target building, which increases players' cost in memorizing the game map and makes the players' gaming experience poor. The methods are not suitable for certain types of games, for example, a map type with a circle as city architecture and radiating to the surrounding. The space of this type of game lacks a coordinate system, and it is difficult to click/tap to locate. At the same time, players cannot customize shortcut function(s) in the methods, and lack a personalized user experience.

In view of the above problems, the embodiments of the present disclosure provide a method and apparatus for controlling land plots in a game and an electronic device. The technology may be applied to scenarios of selecting, moving, decorating or performing other customized operation(s) on land plot(s) in a game or virtual building(s) in the land plot(s).

In an embodiment of the present disclosure, the method for controlling land plots in the game may be run on a local terminal device or a server. When the method for controlling land plots in the game is run on the server, the method may be implemented and carried out based on a cloud interaction system, and the cloud interaction system includes the server and a client device.

In some implementations, various cloud applications may be run under the cloud interaction system, such as cloud games. Taking a cloud game as an example, the cloud game refers to a game mode based on cloud computing. In an operation mode of the cloud game, an entity for operating the game program and an entity for presenting game screen(s) are separated. The storage and operation of the method for controlling land plots in the game are completed on the cloud game server. The role of the client device is for receiving and sending data and presenting the game screen(s). For example, the client device may be a display device with a data transmission function close to the user side, such as a mobile terminal, a TV, a computer, a handheld computer, etc.; but it is the cloud game server in the cloud that is used for information processing. When playing the game, a player operates the client device to send an operation instruction to the cloud game server. The cloud game server runs the game according to the operation instruction, encodes and compresses data such as the game screen(s), and returns the data to the client device through a network. Finally, the client device performs decoding and outputs the game screen(s).

In some implementations, taking a game as an example, a local terminal device stores a game program and is used to present game screen(s). The local terminal device is used to interact with a player through a graphical user interface, that is, the game program is downloaded and installed and run by an electronic device in a conventional manner. The local terminal device may provide the graphical user interface to the player in a variety of ways, for example, the graphical user interface may be rendered and displayed on a display screen of a terminal, or provided to the player through a holographic projection. For example, the local terminal device may include a display screen and a processor, the display screen is used to present a graphical user interface, the graphical user interface includes game screen(s), and the processor is used to run the game, generate the graphical user interface, and control the graphical user interface to be displayed on the display screen.

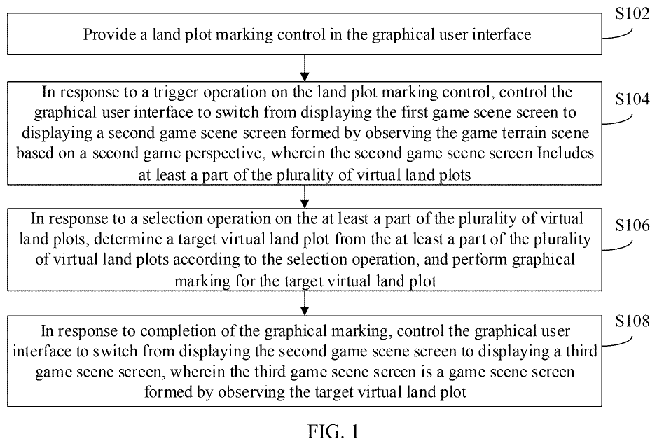

In a possible implementation, an embodiment of the present disclosure provides a method for controlling land plots in a game. A graphical user interface is provided through a terminal device. The terminal device may be the local terminal device mentioned above, or may be a client device in the cloud interaction system mentioned above. A first game scene screen formed by observing a game terrain scene of the game from a first game perspective is displayed on the graphical user interface. The game terrain scene includes a plurality of virtual land plots. The plurality of virtual land plots are used to build one or more virtual units. The one or more virtual units are used to provide corresponding game function(s) in the game. As shown in FIG. 1, the method includes the following specific steps:

In step S102, a land plot marking control is provided in the graphical user interface.

In specific implementation(s), the first game perspective is usually a perspective for observing a local scene in a game terrain scene. For example, the local scene may be a logging position or a position where a certain virtual unit is located, etc. The game terrain scene includes a plurality of virtual land plots, and one or more virtual units are built on each of the land plots. A virtual unit is used to provide a corresponding game function in the game, and the virtual unit may refer to a building or a plant on a virtual land plot, etc. The game function provided by the virtual unit may be a logging function, a spellcasting function, or a decorating function, etc., which is not specifically limited here and may be determined according to a game rule.

The land plot marking control may be displayed at a specified position of the graphical user interface. The specified position may be a position on the right, left, top or bottom of the graphical user interface. The land plot marking control is used to control entry into a land plot marking mode, thereby graphically marking the virtual land plot(s) contained in the game terrain scene.

In step S104, in response to a trigger operation on the land plot marking control, the graphical user interface is controlled to switch from displaying the first game scene screen to displaying a second game scene screen formed by observing the game terrain scene based on a second game perspective. The second game scene screen includes at least a part of the plurality of virtual land plots.

The trigger operation may be a click/tap operation, a drag operation or a sliding operation on the land plot marking control. When a player touches the land plot marking control, the first game scene screen displayed on the graphical user interface is switched to the second game scene screen. The second game scene screen is a game scene screen formed by observing the game terrain scene from the second game perspective. The second game perspective is usually a bird's-eye view. By observing the game terrain scene from a bird's-eye view, the second game scene screen containing all or part of the virtual land plots of the game terrain scene may be obtained.

In step S106, in response to a selection operation on at least a part of the virtual land plots, a target virtual land plot is determined from at least a part of the virtual land plots according to the selection operation, and graphical marking is performed for the target virtual land plot.

The selection operation may be a click/tap operation on a virtual land plot that the player is interested in from at least a part of the virtual land plots, or an operation of performing a frame selection of a virtual land plot that the player is interested in from at least a part of the virtual land plots, or other operation(s) of determining a virtual land plot that the player is interested in from at least a part of the virtual land plots, which are not specifically limited here. The virtual land plot that the player is interested in is the target virtual land plot determined from the at least a part of the virtual land plots.

The above-mentioned graphical marking for the target virtual land plot may be setting a land plot color for the selected target virtual land plot, or setting a name for the selected target virtual land plot, etc.

In step S108, in response to completion of the graphical marking, the graphical user interface is controlled to switch from displaying the second game scene screen to displaying a third game scene screen. The third game scene screen is a game scene screen formed by observing the target virtual land plot.

After the player has completed the graphical marking for the target virtual land plot, the second game scene screen displayed on the graphical user interface is switched to the third game scene screen. The third game scene screen is a game scene screen formed by observing the target virtual land plot, and the game scene screen is a local scene screen. The target virtual land plot in the third game scene screen may be displayed in the middle of the screen according to a preset display format. The preset display format may be set according to research and development requirements, and is not specifically limited here. Specifically, after the graphical marking of the virtual land plot is completed, the graphical user interface switches to the screen formed with the marked position as the center, so that the user can perform operation(s) on the building(s) in the virtual land plot. For example, if a logging site land plot is marked, the graphical user interface switches to a local screen with the logging site land plot as the center.

In the method for controlling land plots in a game provided by the present disclosure, first, in response to the trigger operation on the land plot marking control, the graphical user interface is controlled to switch from displaying the first game scene screen to displaying the second game scene screen formed by observing the terrain scene of the game based on the second game perspective. In response to the selection operation on at least a part of the virtual land plots contained in the second game scene screen, the target virtual land plot is determined from at least a part of the virtual land plots according to the selection operation, and the target virtual land plot is graphically marked. Then, in response to the completion of the graphical marking, the graphical user interface is controlled to switch from displaying the second game scene screen to displaying the third game scene screen, where the third game scene screen is a game scene screen formed by observing the target virtual land plot. In this method, players can graphically mark land plots of interest in the game scene, thereby distinguishing buildings built on different land plots, facilitating players to quickly identify buildings with different game functions, improving operation efficiency, and enhancing players' gaming experience.

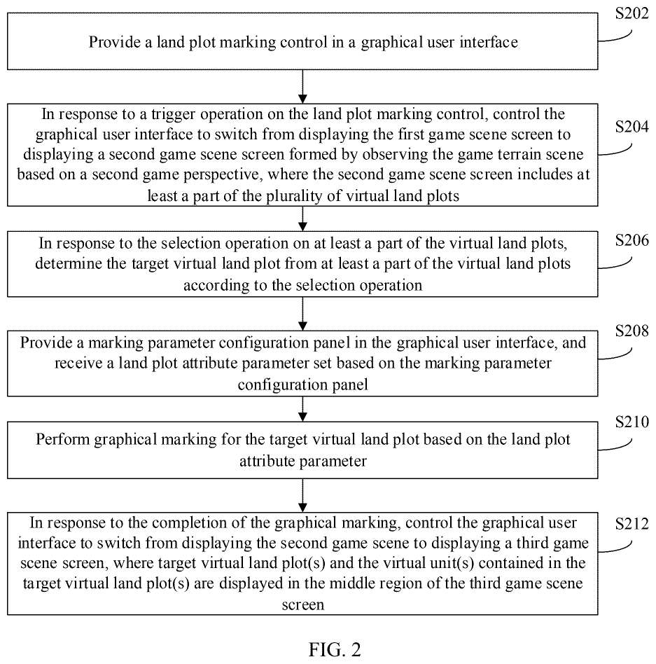

An embodiment of the present disclosure further provides another method for controlling land plots in a game. The method is implemented on the basis of the above embodiment. The method focuses on describing a specific process (implemented through the following steps S206 to S210) of determining the target virtual land plot from at least a part of the virtual land plots according to the selection operation in response to the selection operation on at least a part of the virtual land plots, and graphically marking the target virtual land plot. As shown in FIG. 2, the method includes the following steps:

In step S202, a land plot marking control is provided in a graphical user interface.

In specific implementation(s), an on button and an off button for a land plot marking function are set in a game setting interface in the present disclosure. A player may enter the game setting interface and trigger the on button to turn on the land plot marking function, and trigger the off button to turn off the land plot marking function. When the player turns on the land plot marking function, the land plot marking control is displayed on the graphical user interface. The player may enter a land plot marking mode by triggering the land plot marking control, so as to mark virtual land plot(s) of interest in the game terrain scene from a bird's-eye view.

In step S204, in response to a trigger operation on the land plot marking control, the graphical user interface is controlled to switch from displaying the first game scene screen to displaying a second game scene screen formed by observing the game terrain scene based on a second game perspective. The second game scene screen includes at least a part of the plurality of virtual land plots.

In actual applications, in response to the trigger operation on the land plot marking control, the land plot marking mode is entered, and a close control is displayed on the graphical user interface. The close control is used to close the land plot marking function. This method allows quickly exiting the land plot marking function, so that the player can quickly return to the game.

In step S206, in response to the selection operation on at least a part of the virtual land plots, the target virtual land plot is determined from at least a part of the virtual land plots according to the selection operation.

In a specific implementation, the specific implementation of the above step S206 may include: in response to a click/tap operation on a first virtual land plot in at least a part of the virtual land plots, determining the first virtual land plot as the target virtual land plot. The first virtual land plot may be one or more virtual land plots which are displayed in the second game scene screen and are clicked/tapped by the player. This method can quickly select the target virtual land plot, so as to quickly complete the subsequent graphical marking for the target virtual land plot.

In some embodiments, the target virtual land plot may also be determined by a frame selection method, including: in response to a sliding operation on at least a part of the virtual land plot, determining a virtual land plot which the sliding operation slides across as the target virtual land plot. Specifically, the method may be implemented by the following steps 10 to 11:

In step 10, in response to a click/tap operation on an initial position in the second game scene screen, a click/tap position of the click/tap operation is determined.

When the player performs the frame selection of the target virtual land plot in the second game scene screen, the player first needs to determine the initial position of the target virtual land plot. The initial position may be any position in the game terrain scene displayed in the second game scene screen. That is, the player's click/tap position in the game terrain scene may be determined as the initial position. In actual applications, the game terrain scene is divided into a plurality of virtual land plots. When the player performs a click/tap operation, the click/tap position of the click/tap operation is automatically adsorbed on the vertex of a nearby virtual land plot, and the vertex may be determined as the click/tap position of the click/tap operation.

In step 11, in response to a first sliding operation starting from the click/tap position, virtual land plot(s) which the first sliding operation slides across is (are) determined as the target virtual land plot.

The first sliding operation may be a sliding operation that starts from the click/tap position of the click/tap operation and slides in a specified direction. The specific direction of the specified direction is determined by the player's operation. The virtual land plot(s) which the first sliding operation slides across refers to virtual land plot(s) corresponding to a region of a specified shape that includes the click/tap position and the position that the first sliding operation slides across. That is, when the player slides from the click/tap position in the specified direction, a land plot region with a certain area is created in the game terrain scene, and the shape of the land plot region is of a specified shape, and the specified shape is determined by the shape of the terrain on which the frame selection is performed.

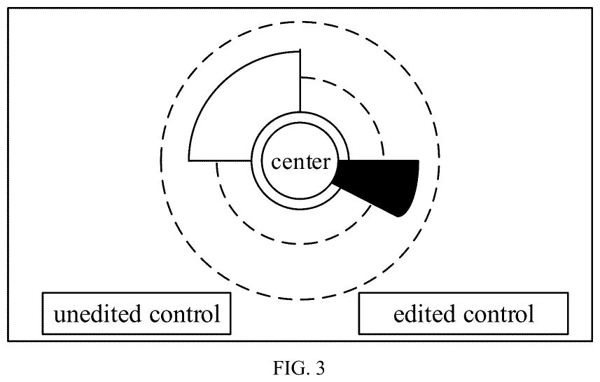

In a specific implementation, the game terrain scene is formed by a plurality of virtual land plots. The specific process of the above step 11 includes: in response to the first sliding operation starting from the click/tap position, determining the virtual land plot(s) which the first sliding operation slides across in the game terrain scene as the target virtual land plot. Specifically, the sliding position of the first sliding operation is automatically adsorbed on the vertex of nearby land plot(s), so that a land plot region with a certain area may be created with the click/tap position as the starting point. As shown in FIG. 3, a schematic diagram of a target virtual land plot provided by an embodiment of the present disclosure is shown. In FIG. 3, the position of the finger is the sliding position of the first sliding operation, and the arc region corresponding to the finger position is the land plot region corresponding to the target virtual land plot. The vertex in the target virtual land plot that is diagonal to the vertex where the finger is located is the click/tap position.

In actual applications, in response to the end of the first sliding operation, a sliding button is displayed at the end position of the first sliding operation; and in response to a second sliding operation starting from the sliding button, the target virtual land plot(s) is (are) adjusted based on the first sliding operation and the second sliding operation. After the first sliding operation ends, the land plot(s) included in the selected target virtual land plot(s) can be further adjusted through the sliding button, so as to facilitate the player to select and determine a satisfactory plot region.

In a specific implementation, in response to the sliding operation on at least a part of the virtual land plots, whether the virtual land plot(s), which the sliding operation slides across, exceeds (exceed) a preset selection range is determined; if the virtual land plot(s), which the sliding operation slides across, exceeds (exceed) the preset selection range, first prompt information is displayed on the graphical user interface, and the virtual land plot(s) which the sliding operation slides across is (are) displayed in a specified color; where the first prompt information is used to indicate that the virtual land plot(s) which the sliding operation slides across exceeds (exceed) the preset selection range.

The specific size of the preset selection range is set by research and development requirements, and the preset selection range may be marked in the second game scene screen to remind the player not to select a virtual land plot that exceeds the preset selection range. If the sliding operation exceeds the preset selection range, prompt information indicating that the preset selection range is exceeded is displayed at a specified position on the graphical user interface, and the target region is displayed in a specified color to make the virtual land plot(s) selected by the player in a prohibited state. The above-mentioned specified position and specified color may be set according to research and development requirements. For example, the specified position may be the top of the graphical user interface, and the specified color may be gray or black, etc.

In a specific implementation, the second game scene screen also includes at least one edited control, and a marked land plot corresponding to each edited control in the second game scene screen. Based on this, in response to the sliding operation acting on at least a part of the virtual land plots, whether the virtual land plot(s), which the sliding operation slides across, overlaps (overlap) with a marked land plot is determined; if there is an overlap, second prompt information is displayed on the graphical user interface, and the virtual plot(s), which the sliding operation slides across, is (are) displayed in a specified color. The second prompt information is used to indicate that the virtual land plot(s), which the sliding operation slides across, overlaps (overlap) with a marked land plot.

Based on the above description, when the player performs a sliding operation on a part of the virtual land plots included in the second game scene screen, the following three cases may occur:
Case 1: The virtual land plot(s), which the sliding operation slides across, exceeds (exceed) the preset selection range, and first prompt information pops up on the graphical user interface, and the virtual land plot(s), which the sliding operation slides across, is (are) displayed in a specified color.
Case 2: The virtual land plot(s), which the sliding operation slides across, overlaps (overlap) with a marked land plot, and second prompt information is displayed on the graphical user interface, and the edited region is displayed in a specified color.
Case 3: The sliding operation successfully performs a frame selection of the target virtual land plot(s).

When the virtual land plot(s), which the sliding operation slides across, neither overlaps (overlap) with a marked land plot nor exceeds (exceed) the preset selection range, the sliding operation ends (that is, the finger leaves the screen), and a land plot confirmation control is displayed on the graphical user interface. The land plot confirmation control may be displayed at the end position of the sliding operation. The land plot confirmation control is used to determine that the virtual land plot(s), which the sliding operation slides across, is (are) the target virtual land plot(s). In a specific implementation, when the sliding operation ends, a re-editing control is also displayed on the graphical user interface; in response to a trigger operation on the re-editing control, the virtual land plot(s), which the sliding operation slides across, is (are) deselected on the graphical user interface. That is, the re-editing control is used for reselecting target virtual land plot(s), that is, for re-executing steps 10 to 11.

In step S208, a marking parameter configuration panel is provided on the graphical user interface, and a land plot attribute parameter set based on the marking parameter configuration panel is received.

In a specific implementation, after the player completes the frame selection of the target virtual land plot(s), the marking parameter configuration panel may be displayed on the graphical user interface; alternatively, an unedited control may be provided in the second game scene screen, and in response to a trigger operation on the unedited control, the marking parameter configuration panel may be provided in the graphical user interface. After the marking parameter configuration panel is displayed on the graphical user interface, the land plot attribute parameter set based on the marking parameter configuration panel is received. The marking parameter configuration panel is used to set the land plot attribute parameter(s) of the target virtual land plot(s). The specific parameter(s) which the land plot attribute parameter(s) includes (includes) can be set according to research and development requirements.

In practical applications, the land plot attribute parameters include a land plot color and a land plot name corresponding to a target virtual land plot; the marking parameter configuration panel includes: a plurality of preset colors, and a name input window. The above-mentioned step S208 may be implemented by the following steps 20 to 22:

In step 20, in response to a trigger operation on an unedited control, a marking parameter configuration panel is provided in the graphical user interface.

The trigger operation on the unedited control may be a click/tap operation, a slide operation, or a drag operation, etc., which is determined according to research and development requirements.

In step 21, in response to a selection operation on a target color from a plurality of preset colors included in the marking parameter configuration panel, a land plot color corresponding to the target virtual land plot is determined to be the target color.

The specific color values of the plurality of preset colors included in the marking parameter configuration panel may be set according to research and development requirements. The selection operation on the target color among the plurality of preset colors may be an operation of clicking/tapping the target color or long pressing the target color in the marking parameter configuration panel.

In step 22, in response to an input operation on the name input window, the land plot name corresponding to the target virtual land plot is determined as the name input through the input operation.

In step S210, graphical marking is performed for the target virtual land plot based on the land plot attribute parameters.

In specific implementation, the target virtual land plot may be graphically marked according to the land plot attribute parameters. That is, the target virtual land plot is marked in the second game scene with the region color indicated by the land plot attribute parameters, and the target virtual land plot is named with the region name indicated by the land plot attribute parameters. This method enables players to clearly distinguish which are the marked land plots and what is the name of each marked land plot region, so that players can subsequently locate and select virtual buildings in the land plot regions.

In step S212, in response to the completion of the graphical marking, the graphical user interface is controlled to switch from displaying the second game scene to displaying a third game scene screen. The target virtual land plot(s) and the virtual unit(s) contained in the target virtual land plot(s) are displayed in the middle region of the third game scene screen.

In the method for controlling plots in a game, a regional land plot marking function is provided, which is convenient for quick switching between local buildings. And, this method changes from a global building click-to-select operation to a regional click-to-select operation, which greatly reduces search costs, reduces complicated operations, and improves game efficiency. At the same time, the customized operation on the land plot region in this method can improve the playability of the game, and the customized modification is convenient for flexible deployment according to the player's current task, thereby improving player participation.

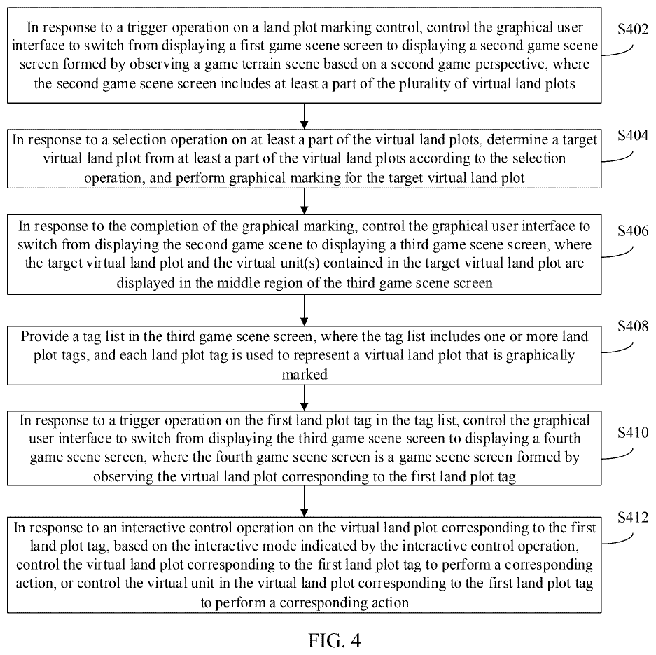

An embodiment of the present disclosure also provides another method for controlling land plots in a game. The method is implemented on the basis of the above embodiment. The method focuses on describing a specific process (implemented by the following step S406) of controlling the switching of the second game scene screen displayed on the graphical user interface to display the third game scene screen in response to completion of the graphical marking. As shown in FIG. 4, the method includes the following steps:

In step S402, in response to a trigger operation on a land plot marking control, the graphical user interface is controlled to switch from displaying a first game scene screen to displaying a second game scene screen formed by observing a game terrain scene based on a second game perspective. The second game scene screen includes at least a part of the plurality of virtual land plots.

In step S404, in response to a selection operation on at least a part of the virtual land plots, a target virtual land plot is determined from at least a part of the virtual land plots according to the selection operation, and graphical marking is performed for the target virtual land plot.

In step S406, in response to the completion of the graphical marking, the graphical user interface is controlled to switch from displaying the second game scene to displaying a third game scene screen. The middle area of the third game scene screen displays the target virtual land plot and the virtual unit(s) contained in the target virtual land plot.

In a specific implementation, after triggering the graphical marking for the target virtual land plot, the camera shot moves to the land plot region corresponding to the target virtual land plot, so that the target virtual land plot is in the center of the graphical user interface and all virtual unit(s) in the target virtual land plot is (are) fully displayed, forming a third game scene screen. Specifically, the step S406 may be implemented by the following steps 30 to 32:

In step 30, in response to the completion of the graphical marking, whether the land plot size of the target virtual land plot is larger than a preset display size is determined; if the land plot size of the target virtual land plot is larger than the preset display size, step 31 is performed; otherwise, step 32 is performed.

The preset display size may be determined according to research and development requirements, and the land plot size of the target virtual land plot may be determined according to the land plot magnitude of the target virtual land plot and a preset scale.

In step 31, the target virtual land plot is displayed in the center of the graphical user interface according to the preset display size.

In step 32, the target virtual land plot is displayed in the center of the graphical user interface according to the land plot size of the target virtual land plot.

In order to ensure the overall uniformity of shot movement and the integrity of the virtual building display in the target virtual land plot, and to avoid switching jerks and unsmoothness caused by excessive differences in zoom, it is needed to display the target virtual land plot according to the preset display size when the land plot size of the target virtual land plot is larger than the preset display size, and to display the target virtual land plot according to the land plot size of the target virtual land plot when the land plot size of the target virtual land plot is smaller than the preset display size.

In some embodiments, a default zoom parameter size of a shot may be provided as X. Assuming that the land plot size of the target virtual land plot is Y, when X≥Y, the parameter for display is X; when X<Y, the parameter for display is Y, so as to ensure the overall uniformity of the shot movement and the integrity of the building display, and avoid screen switching jerks caused by excessive differences in zoom.

In a specific implementation, the edge of the target virtual land plot displayed in the third game scene screen is provided with a glowing border, thereby providing glowing effect display for clearly showing a region range, so as to distinguish from other buildings.

In step S408, a tag list is provided in the third game scene screen. The tag list includes one or more land plot tags, and each land plot tag is used to represent a virtual land plot that is graphically marked.

In a specific implementation, a graphically marked virtual land plot that is correspondingly represented by a land plot tag is marked and obtained in the second game scene screen. The graphically marked virtual land plot that is correspondingly represented by the land plot tag may be a marked land plot in the second game scene screen.

In step S410, in response to a trigger operation on a first land plot tag in the tag list, the graphical user interface is switched from displaying the third game scene screen to displaying a fourth game scene screen. The fourth game scene screen is a game scene screen formed by observing a virtual land plot corresponding to the first land plot tag.

In a specific implementation, the first land plot tag may be any one of the land plot tags in the tag list. After the first land plot tag is triggered, the camera shot moves to the virtual land plot corresponding to the first land plot tag. The virtual land plot corresponding to the first land plot tag is in the center of the overall screen and all virtual buildings in the virtual land plot corresponding to the first land plot tag are fully displayed. At the same time, the edge of the virtual land plot corresponding to the first land plot tag is permanently added with a glowing border, providing glowing effect display for clearly showing a region range, so as to distinguish from other buildings.

In practical applications, in order to ensure the overall uniformity of shot movement and the integrity of the display of virtual buildings in the target virtual land plot, and to avoid the phenomenon of switching jerks and unsmoothness caused by excessive differences in zoom, before displaying the graphically marked virtual land plot on the graphical user interface, the method also includes: determining whether the land plot size of the graphically marked virtual land plot is larger than the preset display size; if the land plot size of the graphically marked virtual land plot is larger than the preset display size, displaying the graphically marked virtual land plot in the center of the graphical user interface according to the preset display size; if the land plot size of the graphically marked virtual land plot is not larger than the preset display size, displaying the graphically marked virtual land plot in the center of the graphical user interface according to the land plot size.

In actual applications, the tag list also includes a reset control. After responding to the trigger operation on the first land plot tag in the tag list and switching the graphical user interface from displaying the third game scene screen to displaying the fourth game scene screen, the method may further respond to a trigger operation on the reset control to control the graphical user interface to switch from displaying the fourth game scene screen to displaying the third game scene screen.

In some embodiments, the game scene screen displayed on the graphical user interface may also be controlled to change according to a sliding operation in response to the sliding operation on the fourth game scene screen; and the fourth game scene screen may be displayed on the graphical user interface in response to a trigger operation on the reset control. This method can facilitate a player to display the virtual land plot corresponding to the land plot tag selected by the player before the scene change in the middle region of the graphical user interface again.

In a specific implementation, the player clicks/taps on the land plot marking control in the fourth game scene screen, and the second game scene screen is displayed on the graphical user interface, in which the virtual land plot corresponding to the first land plot tag is displayed. At this time, the land plot attribute parameter(s) of the virtual land plot corresponding to the first land plot tag can be adjusted in the second game scene screen, and/or the land plot magnitude of the virtual land plot corresponding to the first land plot tag can be adjusted.

In some embodiments, if a land plot tag is clicked/tapped for the first time, a virtual land plot corresponding to the land plot tag and virtual building(s) contained in the virtual land plot corresponding to the land plot tag appear in the middle of the graphical user interface, and the edge of the virtual land plot corresponding to the land plot tag is displayed with a glowing border; if the land plot tag is clicked/tapped again, the camera viewing angle does not change, that is, the scene displayed on the graphical user interface does not change, but the glowing border is cancelled.

In step S412, in response to an interactive control operation on the virtual land plot corresponding to the first land plot tag, based on an interactive mode indicated by the interactive control operation, the virtual land plot corresponding to the first land plot tag is controlled to perform a corresponding action, or a virtual unit in the virtual land plot corresponding to the first land plot tag is controlled to perform a corresponding action.

In specific implementation, the virtual unit usually refers to a virtual building; the interactive control operation may be an operation for moving the target virtual land plot, or the interactive control operation may be an operation of selecting, positioning or decorating a target building in the virtual buildings contained in the target virtual land plot, and the specific method of the interactive control operation can be set according to research and development requirements.

In practical applications, the present disclosure may be applied to the following scenarios:
1) Gameplay of decorating a town with customized land plot:

A player marks land plot tags in advance, and each land plot tag corresponds to a graphically marked virtual land plot. When the player clicks/taps on a land plot tag, the marked land plot corresponding to the land plot tag is displayed on the graphical user interface. The player clicks/taps on a decoration column in a building list, selects a Christmas holiday decoration package, drags it to the marked land plot, and the marked land plot lights up. The virtual buildings and virtual streets in the marked land plot present a Christmas atmosphere with one click/tap. This method can achieve highly personalized expressions of different styles in different land plot regions in the town. All decoration effects can eventually be announced in the world channel, allowing other players to click/tap to enter the town for a visit, leave comments, give likes and so on, based on the visit to the town. The player can view them on a message board after the player goes online.
2) Gameplay of story event for opposing regions:

Combined with the story event gameplay in the game, a player enters the main storyline, clicks/taps on the story guidance, customizes the division into two regions A and B (specifically, the division of the regions may be performed according to the above steps S202 to S208), and give different effects to the two regions during the story time. The region A gets key resource allocation, production efficiency, and increased material mining rate, and the player gets some extra rare materials within the time. The region B gets reduced production, increased crime rate, and eventually a riot event is produced. The player needs to continuously meet the civilian demands in the region and provide enough materials to survive the event. During the story, the player can switch back and forth between region A and region B through presetting the regions to improve the gameplay operability and playability.
3) Gameplay of dividing functions of regions in a city:

A player presets land plot regions in advance. The player uses a beacon system and clicks/taps to randomly draw non-player characters (NPCs) of different types of professions to the town. The player customizes the division of functional regions of the city, such as industrial regions, political regions, entertainment regions, etc. The player drags buildings and builds wood factories, steel mills, coal factories or other similar buildings in a preset region to improve local work efficiency and attract more NPCs with worker attributes to enter the region. Attracting specific gold medal NPCs can also continue to improve the work efficiency of workers in the region and maximize benefits.
4) Gameplay of special law abilities:

Combined with the regions, a special law is issued and implemented in a specific region of the city. A player presets land plot regions in advance and gets the land plot control corresponding to each preset land plot region. The player clicks/taps on a target land plot tag, and the target land plot region corresponding to the target land plot tag is displayed on the graphical interface. The player clicks/taps the law function on the main interface to enter the law release interface; the player clicks/taps and drag the law effect to the target land plot region to implement the function of only imposing the effect on the buildings in the target land plot region. After a certain amount of special law abilities are released in the same region, the land plot shape can be changed to a specified style of the corresponding law, such as a special energy tower style of the faith faction, so as to achieve the purpose of realizing multi-faction and highly customized special laws in the town.

The land plot control method in the above game uses the pre-stored land plots. The camera lens moves to the target land plot area, and the target land plot area is centered in the overall picture and all buildings in the target land plot area are fully displayed. At the same time, the edge of the target land plot area is always illuminated, providing a clear area range light effect display to distinguish other buildings. In addition, this method changes from a global building click-to-select operation to a regional click-to-select operation, which greatly reduces search costs, reduces complicated operations, and improves game efficiency.

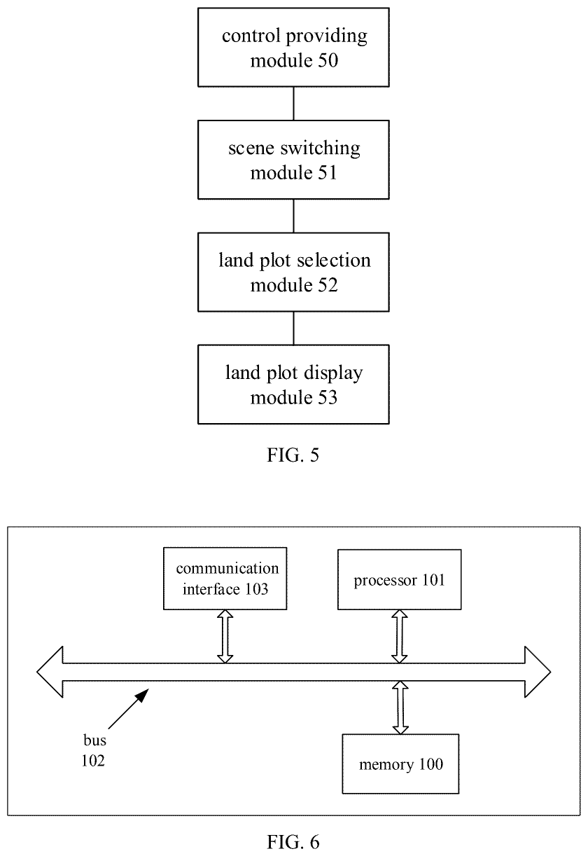

Corresponding to the above method embodiments, an embodiment of the present disclosure further provides an apparatus for controlling land plots in a game. A graphical user interface is provided through a terminal device. A first game scene screen formed by observing a game terrain scene of the game based on a first game perspective is displayed on the graphical user interface. The game terrain scene includes a plurality of virtual land plots. The plurality of virtual land plots are used to build one or more virtual units. The one or more virtual units are used to provide corresponding game function(s) in the game. As shown in FIG. 5, the apparatus includes:
a control providing module 50 configured to provide a land plot marking control in the graphical user interface;
a scene switching module 51 configured to, in response to a trigger operation of the land plot marking control, control the graphical user interface to switch from displaying the first game scene screen to displaying a second game scene screen formed by observing the game terrain scene based on a second game perspective, wherein the second game scene screen includes at least a part of the plurality of virtual land plots;
a land plot selection module 52 configured to, in response to a selection operation on at least a part of the virtual land plots, determine a target virtual land plot from at least a part of the virtual land plots according to the selection operation, and perform graphical marking for the target virtual land plot; and
a land plot display module 53 configured to control the graphical user interface to switch from displaying the second game scene screen to displaying a third game scene screen in response to completion of the graphical marking, wherein the third game scene screen is a game scene screen formed by observing the target virtual land plot.

In the apparatus for interactive control in a game, first, in response to the trigger operation on the land plot marking control, the graphical user interface is controlled to switch from displaying the first game scene screen to displaying the second game scene screen formed by observing the game terrain scene based on the second game perspective. In response to the selection operation on at least a part of the virtual land plots contained in the second game scene screen, the target virtual land plot is determined from at least a part of the virtual land plots according to the selection operation, and the target virtual land plot is graphically marked. Then, in response to the completion of the graphical marking, the graphical user interface is controlled to switch from displaying the second game scene screen to displaying the third game scene screen, wherein the third game scene screen is the game scene screen formed by observing the target virtual land plot. In this way, players can graphically mark the land plots of interest in the game scene, thereby distinguishing the buildings built on different land plots, facilitating players to quickly identify buildings with different game functions, improving operation efficiency, and also enhancing players' gaming experience.

In some embodiments, the land plot selection module 52 includes: a land plot determination unit configured to, in response to the selection operation on at least a part of the virtual land plots, determine the target virtual land plot from at least a part of the virtual land plots according to the selection operation; an attribute marking unit configured to provide a marking parameter configuration panel in the graphical user interface, and receive a land plot attribute parameter set based on the marking parameter configuration panel; and a land plot marking unit configured to graphically mark the target virtual land plot based on the land plot attribute parameter.

In some embodiments, the second game scene screen includes an unedited control; the attribute marking unit is configured to: in response to a trigger operation on the unedited control, provide a marking parameter configuration panel in the graphical user interface, and receive the land plot attribute parameter set based on the marking parameter configuration panel.

In some embodiments, the land plot attribute parameter includes a land plot color and a land plot name corresponding to the target virtual land plot; the marking parameter configuration panel includes: a plurality of preset colors and a name input window. The attribute marking unit is further configured to: in response to a trigger operation on the unedited control, provide a marking parameter configuration panel in the graphical user interface; in response to a selection operation on a target color from the plurality of preset colors contained in the marking parameter configuration panel, determine the land plot color corresponding to the target virtual land plot to be the target color; and in response to an input operation on the name input window, determine the land plot name corresponding to the target virtual land plot as the name input through the input operation.

In some embodiments, the land plot determining unit is configured to: in response to a click/tap operation on a first virtual land plot in at least a part of the virtual land plots, determine the first virtual land plot as a target virtual land plot.

In some embodiments, the land plot determination unit is further configured to: in response to a sliding operation acting on at least a part of the virtual land plot, determine a virtual land plot that the sliding operation slides across as the target virtual land plot.

In some embodiments, the apparatus further includes a first determination module configured to: in response to a sliding operation acting on at least a part of the virtual land plots, determine whether the virtual land plot, that the sliding operation slides across, exceeds a preset selection range; if the virtual land plot, that the sliding operation slides across, exceeds the preset selection range, display first prompt information on the graphical user interface, and display the virtual land plot that the sliding operation slides across in a specified color; wherein first prompt information is used to indicate that the virtual land plot, that the sliding operation slides across, exceeds the preset selection range.

In some embodiments, the second game scene screen further includes at least one edited control, and a marked land plot corresponding to each edited control in the second game scene screen. The apparatus further includes a second determination module configured to: in response to a sliding operation acting on at least a part of the virtual land plots, determine whether the virtual land plot, which the sliding operation slides across, overlaps with a marked land plot; if there is an overlap, display second prompt information on the graphical user interface, and display the virtual land plot which the sliding operation slides across in a specified color; wherein the second prompt information is used to indicate that the virtual land plot, which the sliding operation slides across, overlaps with the marked land plot.

In some embodiments, the land plot display module 53 is further configured to: in response to the completion of graphical marking, control the graphical user interface to switch from displaying the second game scene to displaying a third game scene screen, wherein the target virtual land plot and the virtual unit(s) contained in the target virtual land plot are displayed in the middle region of the third game scene screen.

In some embodiments, the edge of the target virtual land plot displayed in the third game scene screen is provided with a glowing border.

In some embodiments, the apparatus further includes a list providing module configured to: after the graphical user interface is controlled to switch from displaying the second game scene screen to displaying the third game scene screen in response to the completion of the graphical marking, provide a tag list in the third game scene screen; wherein the tag list includes one or more land plot tags, and each land plot tag is used to represent a virtual land plot that is graphically marked.

In some embodiments, the apparatus further includes a land plot switching module configured to: in response to a trigger operation on a first land plot tag in the tag list, switch the third game scene screen displayed on the graphical user interface to display a fourth game scene screen; wherein the fourth game scene screen is a game scene screen formed by observing the virtual land plot corresponding to the first land plot tag.

In some embodiments, the apparatus further includes a display determination module configured to: before the graphically marked virtual land plot is displayed on the graphical user interface, determine whether a land plot size of the graphically marked virtual land plot is larger than a preset display size; if the land plot size of the graphically marked virtual land plot is larger than the preset display size, display the graphically marked virtual land plot in the center of the graphical user interface according to the preset display size; if the land plot size of the graphically marked virtual land plot is not larger than the preset display size, display the graphically marked virtual land plot in the center of the graphical user interface according to the land plot size.

In some embodiments, the tag list further includes a reset control. The apparatus further includes a reset module configured to: after the third game scene screen displayed on the graphical user interface is switched to display the fourth game scene screen in response to the trigger operation on the first land plot tag in the tag list, control the graphical user interface to switch from displaying the fourth game scene screen to displaying the third game scene screen in response to a trigger operation on the reset control.

The apparatus for controlling plots in a game provided by the embodiments of the present disclosure has the same implementation principle and technical effects as those of the aforementioned method embodiments. For the sake of brief description, regarding details not mentioned in the apparatus embodiments, reference may be made to the corresponding contents in the aforementioned method embodiments.

An embodiment of the present disclosure further provides an electronic device. As shown in FIG. 6, the electronic device includes a processor and a memory. The memory stores machine executable instructions that can be executed by the processor, and the processor executes the machine executable instructions to implement the methods for controlling land plots in a game as described above.

Furthermore, the electronic device shown in FIG. 6 further includes a bus 102 and a communication interface 103, and the processor 101, the communication interface 103 and the memory 100 are connected via the bus 102.

The memory 100 may include a high-speed Random Access Memory (RAM), and may also include a non-volatile memory, such as at least one disk storage. The communication connection between the system network element and at least one other network element is realized through at least one communication interface 103 (which may be wired or wireless), and the Internet, wide area network, local area network, metropolitan area network, etc. may be used. The bus 102 may be an ISA bus, a PCI bus or an EISA bus, etc. The bus may be divided into an address bus, a data bus, a control bus, etc. For ease of representation, only one bidirectional arrow is used in FIG. 6, but it does not mean that there is only one bus or one type of bus.

The processor 101 may be an integrated circuit chip with signal processing capabilities. In the implementations, each step of the above methods may be completed by the hardware integrated logic circuit or instructions in a form of software in the processor 101. The processor 101 may be a general-purpose processor, including a Central Processing Unit (CPU), a Network Processor (NP), etc.; the processor 101 may also be a Digital Signal Processor (DSP), an Application Specific Integrated Circuit (ASIC), a Field-Programmable Gate Array (FPGA) or other programmable logic device(s), a discrete gate or a transistor logic device, a discrete hardware component. The methods, steps and logic block diagrams disclosed in the embodiments of the present disclosure may be implemented or carried out. The general-purpose processor may be a microprocessor or the processor may also be any conventional processor, etc. The steps of the methods disclosed in conjunction with the embodiments of the present disclosure may be directly embodied as being performed by a hardware decoding processor, or may be embodied as being performed by a combination of hardware and software modules in the decoding processor. The software module may be located in a mature storage medium in the art, such as a random access memory, a flash memory, a read-only memory, a programmable read-only memory or an electrically erasable programmable memory, a register, etc. The storage medium is located in the memory 100, and the processor 101 reads information in the memory 100, and completes the steps of the methods of the aforementioned embodiments in combination with its hardware. The method provides a graphical user interface through a terminal device. A first game scene screen formed by observing a game terrain scene of a game based on a first game perspective is displayed on the graphical user interface. The game terrain scene includes a plurality of virtual land plots. The plurality of virtual land plots are used to build one or more virtual units. The one or more virtual units are used to provide corresponding game function(s) in the game. The method may include the following steps:
providing a land plot marking control in the graphical user interface;
in response to a trigger operation on the land plot marking control, controlling the graphical user interface to switch from displaying the first game scene screen to displaying a second game scene screen formed by observing the game terrain scene based on a second game perspective, wherein the second game scene screen includes at least a part of the plurality of virtual land plots;
in response to a selection operation on the at least a part of the plurality of virtual land plots, determining a target virtual land plot from the at least a part of the plurality of virtual land plots according to the selection operation, and performing graphical marking for the target virtual land plot; and
in response to completion of the graphical marking, controlling the graphical user interface to switch from displaying the second game scene screen to displaying a third game scene screen, wherein the third game scene screen is a game scene screen formed by observing the target virtual land plot.

In the method, the graphical user interface is controlled to switch from displaying the first game scene screen to displaying the second game scene screen formed by observing the game terrain scene based on the second game perspective in response to the trigger operation on the land plot marking control. In response to the selection operation on at least a part of the virtual land plots contained in the second game scene screen, the target virtual land plot is determined from at least a part of the virtual land plots according to the selection operation, and the target virtual land plot is graphically marked. Then, in response to the completion of the graphical marking, the graphical user interface is controlled to switch from displaying the second game scene screen to displaying the third game scene screen, and the third game scene screen is the game scene screen formed by observing the target virtual land plot. In this method, players can graphically mark the land plots of interest in the game scene, thereby distinguishing the buildings built on different land plots, facilitating players to quickly identify buildings with different game functions, improving operation efficiency, and also enhancing players' gaming experience.

In some embodiments, the step of determining the target virtual land plot from the at least a part of the plurality of virtual land plots according to the selection operation in response to the selection operation on the at least a part of the plurality of virtual land plots, and performing graphical marking for the target virtual land plot may include:
in response to the selection operation on the at least a part of the plurality of virtual land plots, determining the target virtual land plot from the at least a part of the plurality of virtual land plot according to the selection operation;
providing a marking parameter configuration panel in the graphical user interface, and receiving a land plot attribute parameter set based on the marking parameter configuration panel; and
based on the land plot attribute parameter, performing graphical marking for the target virtual land plot.

In some embodiments, the second game scene screen may include an unedited control;
the step of providing the marking parameter configuration panel in the graphical user interface and receiving the land plot attribute parameter set based on the marking parameter configuration panel may include:
in response to a trigger operation on the unedited control, providing a marking parameter configuration panel in the graphical user interface, and receiving the land plot attribute parameter set based on the marking parameter configuration panel.

In some embodiments, the land plot attribute parameter includes a land plot color and a land plot name corresponding to the target virtual land plot, and the marking parameter configuration panel may include: a plurality of preset colors, and a name input window;
the step of providing the marking parameter configuration panel in the graphical user interface in response to the trigger operation on the unedited control and receiving the land plot attribute parameter set based on the marking parameter configuration panel may include:
in response to the trigger operation on the unedited control, providing a marking parameter configuration panel in the graphical user interface;
in response to a selection operation on a target color from the plurality of preset colors included in the marking parameter configuration panel, determining the land plot color corresponding to the target virtual land plot to be the target color; and
in response to an input operation on the name input window, determining the land plot name corresponding to the target virtual land plot to be a name input through the input operation.

In some embodiments, the step of determining the target virtual land plot from the at least a part of the plurality of virtual land plots according to the selection operation in response to the selection operation on the at least a part of the plurality of virtual land plots may include:
in response to a click/tap operation on a first virtual land plot in the at least a part of the plurality of virtual land plots, determining the first virtual land plot as the target virtual land plot.

In some embodiments, the step of determining the target virtual land plot from the at least a part of the plurality of virtual land plots according to the selection operation in response to the selection operation on the at least a part of the plurality of virtual land plots may include:
in response to a sliding operation on the at least a part of the plurality of virtual land plots, determining a virtual land plot, which the sliding operation slides across, as the target virtual land plot.

In some embodiments, the method may further include:
in response to the sliding operation on the at least a part of the plurality of virtual land plots, determining whether the virtual land plot, which the sliding operation slides across, exceeds a preset selection range; and if the virtual land plot, which the sliding operation slides across, exceeds the preset selection range, displaying first prompt information on the graphical user interface, and displaying the virtual land plot, which the sliding operation slides across, in a specified color;
wherein first prompt information is used to indicate that the virtual land plot, which the sliding operation slides across, exceeds the preset selection range.

In some embodiments, the second game scene screen may further include at least one edited control, and a marked land plot corresponding to each edited control in the second game scene screen; the method may further include:
in response to the sliding operation on the at least a part of the plurality of virtual land plots, determining whether the virtual land plot, which the sliding operation slides across, overlaps with a marked land plot; if so, displaying second prompt information on the graphical user interface, and displaying the virtual land plot, which the sliding operation slides across, in a specified color;
wherein the second prompt information is used to indicate that the virtual land plot, which the sliding operation slides across, overlaps with the marked land plot.

In some embodiments, the step of controlling the graphical user interface to switch from displaying the second game scene screen to displaying the third game scene screen in response to the completion of the graphical marking may include:
in response to the completion of the graphical marking, controlling the graphical user interface to switch from displaying the second game scene to displaying the third game scene screen, wherein the target virtual land plot and a virtual unit included in the target virtual land plot are displayed in a middle region of the third game scene screen.

In some embodiments, an edge of the target virtual land plot displayed in the third game scene screen is provided with a glowing border.

In some embodiments, after the step of controlling the graphical user interface to switch from displaying the second game scene screen to displaying the third game scene screen in response to completion of the graphical marking, the method may further include:
providing a tag list in the third game scene screen, wherein the tag list includes one or more land plot tags, and each of the land plot tags is used to represent a graphically marked virtual land plot.

In some embodiments, the method may further include:
in response to a trigger operation on a first land plot tag in the tag list, switching the graphical user interface from displaying the third game scene screen to displaying a fourth game scene screen, wherein the fourth game scene screen is a game scene screen formed by observing a virtual land plot corresponding to the first land plot tag.

In some embodiments, before displaying the graphically marked virtual land plot on the graphical user interface, the method may further include:
determining whether a land plot size of the graphically marked virtual land plot is larger than a preset display size;
if the land plot size of the graphically marked virtual land plot is larger than the preset display size, displaying the graphically marked virtual land plot in a center of the graphical user interface according to the preset display size;
if the land plot size of the graphically marked virtual land plot is not larger than the preset display size, displaying the graphically marked virtual land plot in the center of the graphical user interface according to the land plot size.

In some embodiments, the tag list may further include a reset control;
wherein after the step of switching the graphical user interface from displaying the third game scene screen to displaying the fourth game scene screen in response to the trigger operation on the first land plot tag in the tag list, the method may further include:
in response to a trigger operation on the reset control, controlling the graphical user interface to switch from displaying the fourth game scene screen to displaying the third game scene screen.

An embodiment of the present disclosure also provides a computer-readable storage medium, which stores computer-executable instructions. When the computer-executable instructions are invoked and executed by a processor, the computer-executable instructions cause the processor to implement the methods for controlling land plots in a game as described above. The method provides a graphical user interface through a terminal device. A first game scene screen formed by observing a game terrain scene of the game based on a first game perspective is displayed on the graphical user interface. The game terrain scene includes a plurality of virtual land plots. The plurality of virtual land plots are used to build one or more virtual units. The one or more virtual units are used to provide corresponding game function(s) in the game. The method may include the following steps:
providing a land plot marking control in the graphical user interface;
in response to a trigger operation on the land plot marking control, controlling the graphical user interface to switch from displaying the first game scene screen to displaying a second game scene screen formed by observing the game terrain scene based on a second game perspective, wherein the second game scene screen includes at least a part of the plurality of virtual land plots;
in response to a selection operation on the at least a part of the plurality of virtual land plots, determining a target virtual land plot from the at least a part of the plurality of virtual land plots according to the selection operation, and performing graphical marking for the target virtual land plot; and
in response to completion of the graphical marking, controlling the graphical user interface to switch from displaying the second game scene screen to displaying a third game scene screen, wherein the third game scene screen is a game scene screen formed by observing the target virtual land plot.

In the method, the graphical user interface is controlled to switch from displaying the first game scene screen to displaying the second game scene screen formed by observing the game terrain scene based on the second game perspective in response to the trigger operation on the land plot marking control. In response to the selection operation on at least a part of the virtual land plots contained in the second game scene screen, the target virtual land plot is determined from at least a part of the virtual land plots according to the selection operation, and the target virtual land plot is graphically marked. Then, in response to the completion of the graphical marking, the graphical user interface is controlled to switch from displaying the second game scene screen to displaying the third game scene screen, and the third game scene screen is the game scene screen formed by observing the target virtual land plot. In this method, players can graphically mark the land plots of interest in the game scene, thereby distinguishing the buildings built on different land plots, facilitating players to quickly identify buildings with different game functions, improving operation efficiency, and also enhancing players' gaming experience.

In some embodiments, the step of determining the target virtual land plot from the at least a part of the plurality of virtual land plots according to the selection operation in response to the selection operation on the at least a part of the plurality of virtual land plots, and performing graphical marking for the target virtual land plot may include:
in response to the selection operation on the at least a part of the plurality of virtual land plots, determining the target virtual land plot from the at least a part of the plurality of virtual land plot according to the selection operation;
providing a marking parameter configuration panel in the graphical user interface, and receiving a land plot attribute parameter set based on the marking parameter configuration panel; and
based on the land plot attribute parameter, performing graphical marking for the target virtual land plot.

In some embodiments, the second game scene screen may include an unedited control;
the step of providing the marking parameter configuration panel in the graphical user interface and receiving the land plot attribute parameter set based on the marking parameter configuration panel may include:
in response to a trigger operation on the unedited control, providing a marking parameter configuration panel in the graphical user interface, and receiving the land plot attribute parameter set based on the marking parameter configuration panel.

In some embodiments, the land plot attribute parameter includes a land plot color and a land plot name corresponding to the target virtual land plot, and the marking parameter configuration panel may include: a plurality of preset colors, and a name input window;
the step of providing the marking parameter configuration panel in the graphical user interface in response to the trigger operation on the unedited control and receiving the land plot attribute parameter set based on the marking parameter configuration panel may include:
in response to the trigger operation on the unedited control, providing a marking parameter configuration panel in the graphical user interface;
in response to a selection operation on a target color from the plurality of preset colors included in the marking parameter configuration panel, determining the land plot color corresponding to the target virtual land plot to be the target color; and
in response to an input operation on the name input window, determining the land plot name corresponding to the target virtual land plot to be a name input through the input operation.

In some embodiments, the step of determining the target virtual land plot from the at least a part of the plurality of virtual land plots according to the selection operation in response to the selection operation on the at least a part of the plurality of virtual land plots may include:
in response to a click/tap operation on a first virtual land plot in the at least a part of the plurality of virtual land plots, determining the first virtual land plot as the target virtual land plot.

In some embodiments, the step of determining the target virtual land plot from the at least a part of the plurality of virtual land plots according to the selection operation in response to the selection operation on the at least a part of the plurality of virtual land plots may include:
in response to a sliding operation on the at least a part of the plurality of virtual land plots, determining a virtual land plot, which the sliding operation slides across, as the target virtual land plot.

In some embodiments, the method may further include:
in response to the sliding operation on the at least a part of the plurality of virtual land plots, determining whether the virtual land plot, which the sliding operation slides across, exceeds a preset selection range; and if the virtual land plot, which the sliding operation slides across, exceeds the preset selection range, displaying first prompt information on the graphical user interface, and displaying the virtual land plot, which the sliding operation slides across, in a specified color;
wherein first prompt information is used to indicate that the virtual land plot, which the sliding operation slides across, exceeds the preset selection range.

In some embodiments, the second game scene screen may further include at least one edited control, and a marked land plot corresponding to each edited control in the second game scene screen; the method may further include:
in response to the sliding operation on the at least a part of the plurality of virtual land plots, determining whether the virtual land plot, which the sliding operation slides across, overlaps with a marked land plot; if so, displaying second prompt information on the graphical user interface, and displaying the virtual land plot, which the sliding operation slides across, in a specified color;
wherein the second prompt information is used to indicate that the virtual land plot, which the sliding operation slides across, overlaps with the marked land plot.

In some embodiments, the step of controlling the graphical user interface to switch from displaying the second game scene screen to displaying the third game scene screen in response to the completion of the graphical marking may include:
in response to the completion of the graphical marking, controlling the graphical user interface to switch from displaying the second game scene to displaying the third game scene screen, wherein the target virtual land plot and a virtual unit included in the target virtual land plot are displayed in a middle region of the third game scene screen.

In some embodiments, an edge of the target virtual land plot displayed in the third game scene screen is provided with a glowing border.

In some embodiments, after the step of controlling the graphical user interface to switch from displaying the second game scene screen to displaying the third game scene screen in response to completion of the graphical marking, the method may further include:
providing a tag list in the third game scene screen, wherein the tag list includes one or more land plot tags, and each of the land plot tags is used to represent a graphically marked virtual land plot.

In some embodiments, the method may further include:
in response to a trigger operation on a first land plot tag in the tag list, switching the graphical user interface from displaying the third game scene screen to displaying a fourth game scene screen, wherein the fourth game scene screen is a game scene screen formed by observing a virtual land plot corresponding to the first land plot tag.

In some embodiments, before displaying the graphically marked virtual land plot on the graphical user interface, the method may further include:
determining whether a land plot size of the graphically marked virtual land plot is larger than a preset display size;
if the land plot size of the graphically marked virtual land plot is larger than the preset display size, displaying the graphically marked virtual land plot in a center of the graphical user interface according to the preset display size;
if the land plot size of the graphically marked virtual land plot is not larger than the preset display size, displaying the graphically marked virtual land plot in the center of the graphical user interface according to the land plot size.

In some embodiments, the tag list may further include a reset control;
after the step of switching the graphical user interface from displaying the third game scene screen to displaying the fourth game scene screen in response to the trigger operation on the first land plot tag in the tag list, the method may further include:
in response to a trigger operation on the reset control, controlling the graphical user interface to switch from displaying the fourth game scene screen to displaying the third game scene screen.

If the functions are implemented in the form of software functional units and sold or used as an independent product, they may be stored in a computer-readable storage medium. Based on this understanding, the technical solutions of the present disclosure, or the part that contributes to the prior art or the part of the technical solutions, may be embodied in the form of a software product. The computer software product is stored in a storage medium, including a plurality of instructions to cause a computer device (which may be a personal computer, a terminal device, or a network device, etc.) to perform all or a part of the steps of the methods described in the embodiments of the present disclosure. The storage medium includes various types of mediums that can store program codes, such as, a U disk, a mobile hard disk, a Read-Only Memory (ROM), a Random Access Memory (RAM), a magnetic disk or an optical disk, etc.

In the description of the present disclosure, it should be noted that the terms “center”, “upper”, “lower”, “left”, “right”, “vertical”, “horizontal”, “inner”, “outer”, etc., indicating the orientation or positional relationships, are based on the orientation or positional relationships shown in the drawings, and are only for the convenience of describing the present disclosure and simplifying the description, rather than indicating or implying that the mentioned apparatus (apparatuses) or element(s) must have a specific orientation or must be constructed and operated in a specific orientation, and therefore these terms cannot be understood as a limitation of the present disclosure. In addition, the terms “first”, “second”, and “third” are used for descriptive purposes only, and cannot be understood as indicating or implying relative importance.

Finally, it should be noted that the above-described embodiments are only example implementations of the present disclosure, which are used to illustrate the technical solutions of the present disclosure, rather than to limit the present disclosure. The protection scope of the present disclosure is not limited to the embodiments described herein. Although the present disclosure is described in detail with reference to the above-described embodiments, those of ordinary skill in this art should understand that any technician familiar with the technical field can still modify the technical solutions in the above-described embodiments within the technical scope disclosed in the present disclosure, or can easily think of changes, or make equivalent replacements for some of the technical features described herein; and these modifications, changes or replacements do not make the essence of corresponding technical solutions deviate from the spirit and scope of the technical solutions of the embodiments of the present disclosure, and should be included in the protection scope of the present disclosure. Therefore, the protection scope of the present disclosure should be determined by the protection scope of the claims.

1. A method controlling land plots in a game,
wherein the method comprises:
providing a land plot marking control in a graphical user interface provided by a terminal device, wherein a first game scene screen formed by observing a game terrain scene of the game based on a first game perspective is displayed on the graphical user interface, and the game terrain scene comprises a plurality of virtual land plots;
in response to a trigger operation on the land plot marking control, controlling the graphical user interface to switch from displaying the first game scene screen to displaying a second game scene screen formed by observing the game terrain scene based on a second game perspective, wherein the second game scene screen comprises at least a part of the plurality of virtual land plots;
in response to a selection operation on the at least a part of the plurality of virtual land plots, determining a target virtual land plot from the at least a part of the plurality of virtual land plots according to the selection operation, and performing graphical marking for the target virtual land plot; and
in response to completion of the graphical marking, controlling the graphical user interface to switch from displaying the second game scene screen to displaying a third game scene screen, wherein the third game scene screen is a game scene screen formed by observing the target virtual land plot.

2. The method according to claim 1, wherein determining the target virtual land plot from the at least a part of the plurality of virtual land plots according to the selection operation in response to the selection operation on the at least a part of the plurality of virtual land plots, and performing graphical marking for the target virtual land plot comprises:
in response to the selection operation on the at least a part of the plurality of virtual land plots, determining the target virtual land plot from the at least a part of the plurality of virtual land plot according to the selection operation;
providing a marking parameter configuration panel in the graphical user interface, and receiving a land plot attribute parameter set based on the marking parameter configuration panel; and
based on the land plot attribute parameter, performing graphical marking for the target virtual land plot.

3. The method according to claim 2, wherein the second game scene screen comprises an unedited control;
wherein providing the marking parameter configuration panel in the graphical user interface and receiving the land plot attribute parameter set based on the marking parameter configuration panel comprises:
in response to a trigger operation on the unedited control, providing the marking parameter configuration panel in the graphical user interface, and receiving the land plot attribute parameter set based on the marking parameter configuration panel.

4. The method according to claim 3, wherein the land plot attribute parameter comprises a land plot color and a land plot name corresponding to the target virtual land plot, and the marking parameter configuration panel comprises: a plurality of preset colors, and a name input window;
wherein providing the marking parameter configuration panel in the graphical user interface in response to the trigger operation on the unedited control and receiving the land plot attribute parameter set based on the marking parameter configuration panel comprises:
in response to the trigger operation on the unedited control, providing the marking parameter configuration panel in the graphical user interface;
in response to a selection operation on a target color from the plurality of preset colors comprised in the marking parameter configuration panel, determining the land plot color corresponding to the target virtual land plot to be the target color; and
in response to an input operation on the name input window, determining the land plot name corresponding to the target virtual land plot to be a name input through the input operation.

5. The method according to claim 2, wherein determining the target virtual land plot from the at least a part of the plurality of virtual land plots according to the selection operation in response to the selection operation on the at least a part of the plurality of virtual land plots comprises:
in response to a click or tap operation on a first virtual land plot in the at least a part of the plurality of virtual land plots, determining the first virtual land plot as the target virtual land plot.

6. The method according to claim 2, wherein determining the target virtual land plot from the at least a part of the plurality of virtual land plots according to the selection operation in response to the selection operation on the at least a part of the plurality of virtual land plots comprises:
in response to a sliding operation on the at least a part of the plurality of virtual land plots, determining at least one virtual land plot, which the sliding operation slides across, as the target virtual land plot.

7. The method according to claim 6, further comprising:
in response to the sliding operation on the at least a part of the plurality of virtual land plots, determining whether the at least one virtual land plot, which the sliding operation slides across, exceeds a preset selection range; and
in response to the at least one virtual land plot, which the sliding operation slides across, exceeding the preset selection range, displaying first prompt information on the graphical user interface, and displaying the at least one virtual land plot, which the sliding operation slides across, in a specified color;
wherein first prompt information is used to indicate that the at least one virtual land plot, which the sliding operation slides across, exceeds the preset selection range.

8. The method according to claim 6, wherein the second game scene screen further comprises at least one edited control, and a marked land plot corresponding to each of the at least one edited control in the second game scene screen;
wherein the method further comprises:
in response to the sliding operation on the at least a part of the plurality of virtual land plots, determining whether the at least one virtual land plot, which the sliding operation slides across, overlaps with a marked land plot;
in response to the at least one virtual land plot, which the sliding operation slides across, overlapping with the marked land plot, displaying second prompt information on the graphical user interface, and displaying the at least one virtual land plot, which the sliding operation slides across, in a specified color;
wherein the second prompt information is used to indicate that the at least one virtual land plot, which the sliding operation slides across, overlaps with the marked land plot.

9. The method according to claim 1, wherein controlling the graphical user interface to switch from displaying the second game scene screen to displaying the third game scene screen in response to the completion of the graphical marking comprises:
in response to the completion of the graphical marking, controlling the graphical user interface to switch from displaying the second game scene screen to displaying the third game scene screen, wherein the target virtual land plot and a virtual unit comprised in the target virtual land plot are displayed in a middle region of the third game scene screen.

10. The method according to claim 9, wherein an edge of the target virtual land plot displayed in the third game scene screen is provided with a glowing border.

11. The method according to claim 1, wherein after controlling the graphical user interface to switch from displaying the second game scene screen to displaying the third game scene screen in response to completion of the graphical marking, the method further comprises:
providing a tag list in the third game scene screen, wherein the tag list comprises one or more land plot tags, and each of the land plot tags is used to represent a graphically marked virtual land plot.

12. The method according to claim 11, further comprising:
in response to a trigger operation on a first land plot tag in the tag list, switching the graphical user interface from displaying the third game scene screen to displaying a fourth game scene screen, wherein the fourth game scene screen is a game scene screen formed by observing a virtual land plot corresponding to the first land plot tag.

13. The method according to claim 12, wherein before displaying the graphically marked virtual land plot on the graphical user interface, the method further comprises:
determining whether a land plot size of the graphically marked virtual land plot is larger than a preset display size;
in response to the land plot size of the graphically marked virtual land plot being larger than the preset display size, displaying the graphically marked virtual land plot in a center of the graphical user interface according to the preset display size;
in response to the land plot size of the graphically marked virtual land plot being not larger than the preset display size, displaying the graphically marked virtual land plot in the center of the graphical user interface according to the land plot size.

14. The method according to claim 12, wherein the tag list further comprises a reset control;
wherein after switching the graphical user interface from displaying the third game scene screen to displaying the fourth game scene screen in response to the trigger operation on the first land plot tag in the tag list, the method further comprises:
in response to a trigger operation on the reset control, controlling the graphical user interface to switch from displaying the fourth game scene screen to displaying the third game scene screen.

15. (canceled)

16. An electronic device comprising a processor and a memory, wherein the memory stores machine executable instructions that can be executed by the processor, and when the processor executes the machine executable instructions, the electronic device is caused to:
provide a land plot marking control in a graphical user interface provided by a terminal device, wherein a first game scene screen formed by observing a game terrain scene of the game based on a first game perspective is displayed on the graphical user interface, and the game terrain scene comprises a plurality of virtual land plots;
in response to a trigger operation on the land plot marking control, control the graphical user interface to switch from displaying the first game scene screen to displaying a second game scene screen formed by observing the game terrain scene based on a second game perspective, wherein the second game scene screen comprises at least a part of the plurality of virtual land plots;
in response to a selection operation on the at least a part of the plurality of virtual land plots, determine a target virtual land plot from the at least a part of the plurality of virtual land plots according to the selection operation, and perform graphical marking for the target virtual land plot; and
in response to completion of the graphical marking, control the graphical user interface to switch from displaying the second game scene screen to displaying a third game scene screen, wherein the third game scene screen is a game scene screen formed by observing the target virtual land plot.

17. A non-transitory computer-readable storage medium storing computer-executable instructions, wherein when the computer-executable instructions are invoked and executed by a processor, the computer-executable instructions cause the processor to:
provide a land plot marking control in a graphical user interface provided by a terminal device, wherein a first game scene screen formed by observing a game terrain scene of the game based on a first game perspective is displayed on the graphical user interface, and the game terrain scene comprises a plurality of virtual land plots;
in response to a trigger operation on the land plot marking control, control the graphical user interface to switch from displaying the first game scene screen to displaying a second game scene screen formed by observing the game terrain scene based on a second game perspective, wherein the second game scene screen comprises at least a part of the plurality of virtual land plots;
in response to a selection operation on the at least a part of the plurality of virtual land plots, determine a target virtual land plot from the at least a part of the plurality of virtual land plots according to the selection operation, and performing graphical marking for the target virtual land plot; and
in response to completion of the graphical marking, control the graphical user interface to switch from displaying the second game scene screen to displaying a third game scene screen, wherein the third game scene screen is a game scene screen formed by observing the target virtual land plot.

18. The method according to claim 6, wherein determining the at least one virtual land plot, which the sliding operation slides across, as the target virtual land plot in response to the sliding operation on the at least a part of the plurality of virtual land plots, comprises:
in response to a click or tap operation on an initial position in the second game scene screen, determining a click or tap position of the click or tap operation;
in response to a first sliding operation starting from the click or tap position, determining at least one virtual land plot, which the first sliding operation slides across, as the target virtual land plot.

19. The method according to claim 18, further comprising:
in response to ending of the first sliding operation, displaying a sliding button at an end position of the first sliding operation; and
in response to a second sliding operation starting from the sliding button, adjusting the target virtual land plot based on the first sliding operation and the second sliding operation.

20. The electronic device according to claim 16, wherein the processor executes the machine executable instructions, the electronic device is caused to:
in response to the selection operation on the at least a part of the plurality of virtual land plots, determine the target virtual land plot from the at least a part of the plurality of virtual land plot according to the selection operation;
provide a marking parameter configuration panel in the graphical user interface, and receive a land plot attribute parameter set based on the marking parameter configuration panel; and
based on the land plot attribute parameter, perform graphical marking for the target virtual land plot.

21. The electronic device according to claim 20, wherein the second game scene screen comprises an unedited control;
wherein the processor executes the machine executable instructions, the electronic device is caused to:
in response to a trigger operation on the unedited control, provide the marking parameter configuration panel in the graphical user interface, and receive the land plot attribute parameter set based on the marking parameter configuration panel.
